(19) United States
(12) Patent Application Publication
(10) Pub. No.: US 2016/0122214 A1
(43) Pub. Date: May 5, 2016

(54) BIO-BLOCK

(71) Applicant: CHING-CHAO LIN, TAINAN CITY (TW)

(72) Inventor: CHING-CHAO LIN, TAINAN CITY (TW)

(21) Appl. No.: 14/988,200

(22) Filed: Jan. 5, 2016

Related U.S. Application Data
(63) Continuation-in-part of application No. 14/076,375, filed on Nov. 11, 2013.

(51) Int. Cl. C02F 3/10

(52) U.S. Cl. CPC C02F 3/109

(57) ABSTRACT

A bio-block has a main body provided with at least one through hole. The through hole foil is two openings in two surfaces of the main body respectively and has a diameter of 2.5±0.25 mm and a depth of 10.0±1.0 mm When the main body is immersed in a liquid, the surface tension or viscosity generated at the two openings of the through hole guides the liquid rapidly into the through hole and makes the liquid stay in the through hole without flowing through the through hole immediately. Thus, the bio-block retains the liquid in the through hole. The liquid in the through hole can be used to grow microorganisms or plankton such as bacteria, microalgae, and SS-type rotifers. Given the same volume, the bio-block can cultivate various microorganisms and plankton in larger quantities and at higher speed than similar products.

### CROSS-REFERENCE TO RELATED APPLICATIONS

This application is a continuation-in-part of U.S. patent application Ser. No. 14/076,375 filed on Nov. 11, 2013, currently pending.

### BACKGROUND OF THE INVENTION

1. Technical Field

The present invention relates to a bio-block and more particularly to a bio-block structure with at least one through hole in which a liquid can be retained by the surface tension or viscosity generated by the liquid itself, and in which microorganisms or plankton such as bacteria, microalgae, and SS-type rotifers can be grown in the water retained.

2. Description of Related Art

Nowadays, filters for use in aquaria or aquaculture may use physical or biological filtration media. Biological filtration media are the more effective and include bio-balls and bio-blocks, both designed to cultivate bacteria, such as nitrifying bacteria, for water purification purposes.

For example, Taiwan Utility Model Patent No. M280855, published on Nov. 21, 2005 and titled “BIOLOGICAL FILTRATION MEDIUM FOR WATER PURIFICATION”, discloses a biological filtration medium with a spherical hollow interior, which renders the filtration medium ineffective in water retention. Moreover, when the filtration medium is placed in water, not all of its inner and outer portions will be in contact with the dissolved oxygen or ammonia in the water. In other words, the area available for bacteria cultivation is quite limited, and this results in a wasteful use of the filtration medium. Besides, the oxygen-dissolving effect is compromised by difficulties in water exchange between the interior and exterior of the filtration medium.

Taiwan Invention Patent No. 293243, published on Dec. 11, 1996 and titled “POROUS GLASS-FIBER CERAMIC FILTRATION MEDIUM FOR USE IN AQUARIUM”, discloses a ceramic filtration medium with a plurality of radiating pointed fins and corresponding holes. Not only is this structure complicated, but also it is impossible to series-connect multiple such filtration media together for use. In addition, the bulky structure requires a large amount of material for manufacture and cannot be installed without taking up a considerable amount of the filtration space. Its low water retaining ability also hinders the attainment of the optimal oxygen-dissolving effect. In short, this filtration medium leaves much to be desired in use.

Taiwan Invention Patent No. 463854, published on Nov. 11, 2001 and titled “DEVICE FOR CULTIVATING BACTERIA IN WATER IN TOILET TANK”, discloses a biological filtration medium shaped as a straight tube, whose great length, however, prevents water from entering the tube through its two ends and impedes water exchange between the interior and exterior of the tube. Consequently, there tends to be a discontinuity of water in the middle section of the biological filtration medium, meaning not all parts of the filtration medium will be in contact with the dissolved oxygen or ammonia in the water, and a poor oxygen-dissolving effect follows. Now that the area available for cultivating nitrifying bacteria is still limited, this filtration medium does not perform well, either.

US Patent Application No. 20100101994, published on Apr. 29, 2010 and titled “WASTEWATER FILTERING MEDIUM”, discloses a medium with a through hole, whose inner wall is circumferentially provided with circular ribs and is longitudinally provided with elongated ribs intersecting the circular ribs. It is claimed that bacteria can cling on the inner wall to filter wastewater flowing through the through hole. However, as the through hole allows wastewater to flow directly therethrough, the flowing wastewater makes it impossible for bacteria to attach to the inner wall, let alone reproduce. The filtering effect of this filtering medium is therefore poor.

### BRIEF SUMMARY OF THE INVENTION

In view of the foregoing drawbacks of the existing filtration media during use, the present invention provides a bio-block whose main body is provided with at least one through hole. The through hole forms two openings in the main body and has a diameter of 2.5±0.25 mm and a depth of 10.0±1.0 mm When the main body is immersed in a liquid, the through hole retains the liquid flowing therein, and the liquid retained in the through hole generates surface tension or viscosity at the two openings and is thereby kept from flowing through the through hole. The liquid in the through hole can be used to cultivate a microorganism or a plankter.

The main body is a cube or a cylinder and has at least two surfaces, in which the two openings are formed respectively.

The cross-sectional shape of the through hole is circular or square.

If the cross-sectional shape of the through hole is square, the diameter of the through hole refers to the distance between any two opposite sides, or the length of either diagonal, of the cross-sectional shape.

The technical features described above have the following advantages:

1. As the through hole penetrates the main body and has a very small diameter, the surface tension or viscosity generated at the two openings by the liquid in the through hole retains the liquid in the through hole and makes the liquid stay in the through hole without flowing through the through hole immediately. Thus, the bio-block is suitable for growing microorganisms or plankton capable of cleaning wastewater.

2. The liquid retained in the middle section of the through hole can be used to cultivate bacteria and microorganisms. Since the liquid retained will not dry out right away, the cultivated bacteria and microorganisms can live as long as they are allowed. The microorganisms or plankton can be brought into direct contact with, feed on, and take nutrients from, wastewater via the two openings.

3. The through hole in the main body of each bio-block of the present invention is capable of liquid retention so that the maximum amount of liquid can be retained in a limited volume to enhance the attachment and growth of microorganisms or plankton.

### BRIEF DESCRIPTION OF THE SEVERAL VIEWS OF THE DRAWINGS

FIG. 1 is a sectional perspective view of the bio-block in the first embodiment of the present invention;

FIG. 2 schematically shows how the bio-block in the first embodiment of the present invention can be used;

FIG. 3 schematically shows how the bio-block in the first embodiment of the present invention generates surface tension;

FIG. 4 is a sectional perspective view of the bio-block in the second embodiment of the present invention;

FIG. 5 schematically shows how the bio-block in the second embodiment of the present invention can be used;

FIG. 6 is a sectional perspective view of the bio-block in the third embodiment of the present invention;

FIG. 7 schematically shows how the bio-block in the third embodiment of the present invention can be used;

FIG. 8 is a sectional perspective view of the bio-block in the fourth embodiment of the present invention; and

FIG. 9 schematically shows how the bio-block in the fourth embodiment of the present invention can be used.

### DETAILED DESCRIPTION OF THE INVENTION

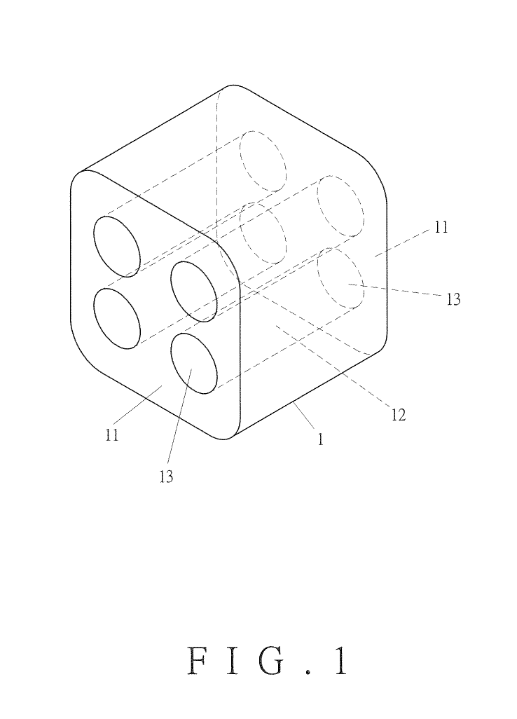

Referring to FIG. 1, the bio-block in the first embodiment of the present invention has a cubic main body 1 with at least two surfaces 11. The main body 1 is provided with at least one through hole 12 having a circular cross section. The through hole 12 has a diameter of 2.5±0.25 mm and a depth of 10.0±1.0 mm The through hole 12 forms an opening 13 in each of the two surfaces 11.

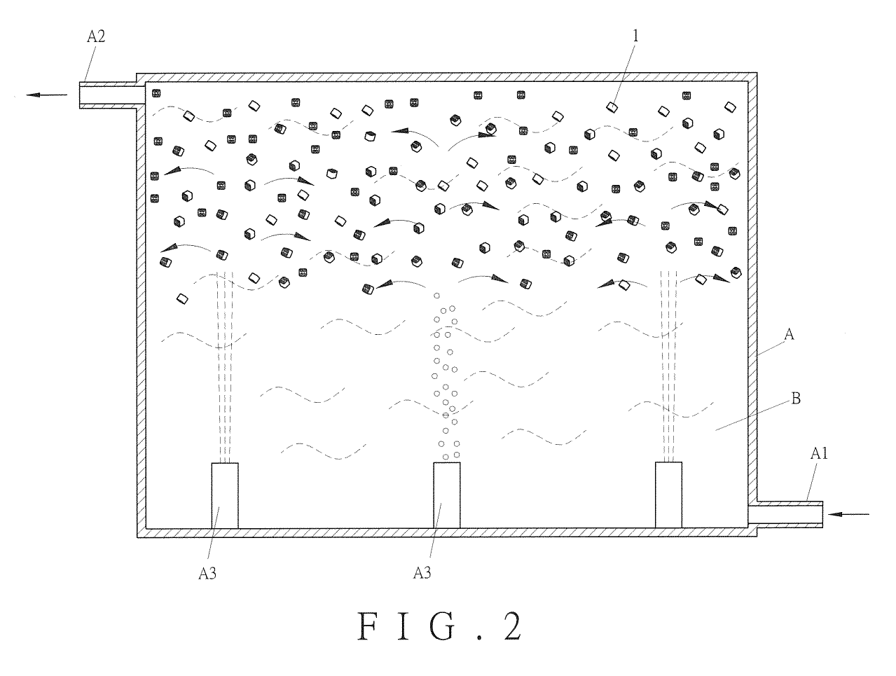

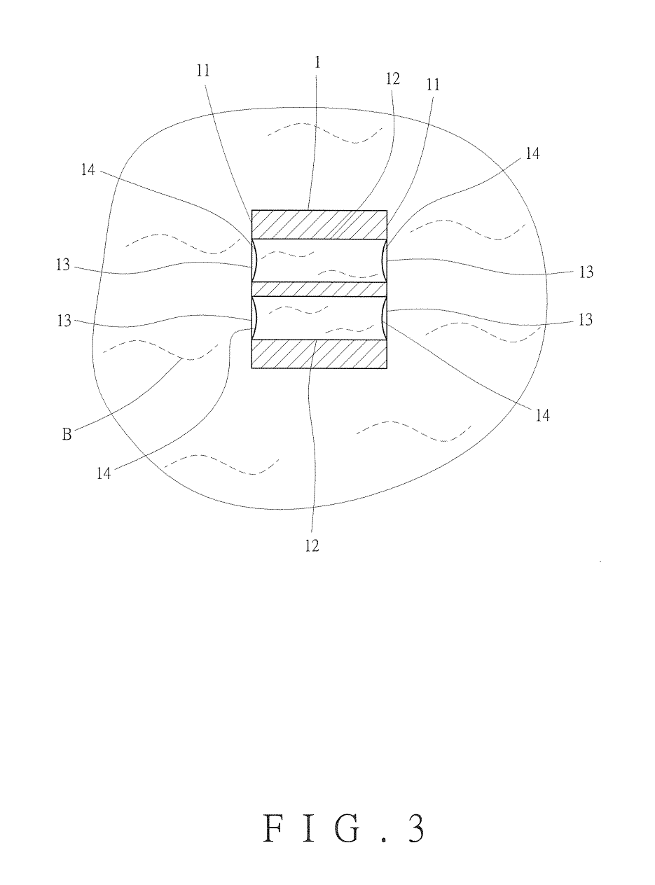

To use, an appropriate number of main bodies 1 can be beforehand immersed in a desirable nutrient medium, such as liquid with microorganisms or plankton (e.g., bacteria, microalgae, and SS-type rotifers) cultivated therein. Due to their small diameters, the through holes 12 of the main bodies 1 can retain the desirable nutrient medium therein. More specifically, the surface tension 14 or viscosity (see FIG. 3) generated at the two openings 13 of each through hole 12 guides the desirable nutrient medium rapidly into the through hole 12 and keeps the desirable nutrient medium staying in the through hole 12 without flowing through the through hole 12 immediately, thereby retaining the desirable nutrient medium in the through hole 12. In this embodiment, the main bodies 1 are beforehand immersed in a nutrient medium cultivated with nitrifying bacteria by way of example. The nutrient medium retained in the middle section of each through hole 12 enables reproduction of nitrifying bacteria and will not dry out. After that, referring to FIG. 1 and FIG. 2, the main bodies 1 with the nutrient medium retained therein are placed in a filter tank A. The wastewater B to be filtered is guided into the filter tank A through a water inlet A1 while the filtered wastewater B is output through a water outlet A2. The ingoing wastewater B may undergo an oxygen-dissolving treatment before it is guided into the filter tank A, with a view to increasing the oxygen content of the wastewater B. Preferably, a water flow or bubbles are input into the filter tank A via at least one dynamic water-flow outlet A3 in order for the water flow or bubbles to hit the main bodies 1 in the filter tank A. Any main body 1 directly hit by the water flow or bubbles is subjected to a pushing force and therefore unbalanced, turning continuously in the wastewater B. Meanwhile, the nitrifying bacteria can be in contact with the wastewater B via the two openings 13 of each through hole 12 so as to feed on and take nutrients from the wastewater B. Therefore, the nitrifying bacteria in the nutrient medium in each through hole 12 can live as long as they are allowed. Moreover, while each main body 1 turns and makes contact with the wastewater B, the nitrifying bacteria can purify the wastewater B via the two openings 13 of each through hole 12 by completely decomposing the ammonia in the wastewater B. Also, the nitrifying bacteria can absorb the dissolved oxygen in the wastewater B via the two openings 13 of each through hole 12 to significantly increase the speed of growth, and hence the quantity, of the nitrifying bacteria, thereby raising their decomposing efficiency. The present invention is so designed that the through holes 12 can be beforehand occupied by the nutrient medium and therefore the surface tension or viscosity generated at the two openings 13 of each through hole 12 prevents the wastewater B from pouring in the through holes 12, thereby maintaining water quality in the through holes 12 for bacterial reproduction.

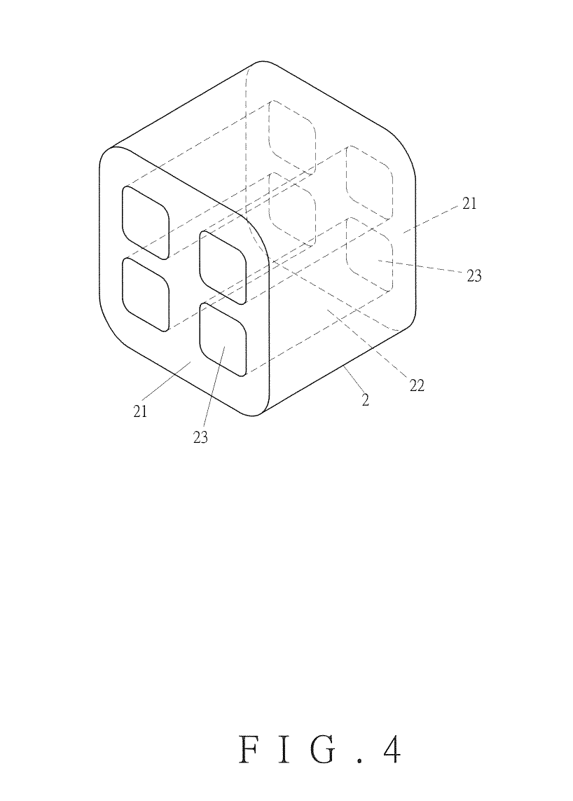

Referring to FIG. 4 for the bio-block in the second embodiment of the present invention, the bio-block has a cubic main body 2 with at least two surfaces 21. The main body 2 is provided with at least one through hole 22 having a square cross section. The through hole 22 has a diameter of 2.5±0.25 mm, wherein the diameter of the through hole 22 refers to the distance between any two opposite sides, or the length of either diagonal, of the square cross section. Also, the through hole 22 has a depth of 10.0±1.0 mm. The through hole 22 forms two openings 23 in the two surfaces 21 respectively.

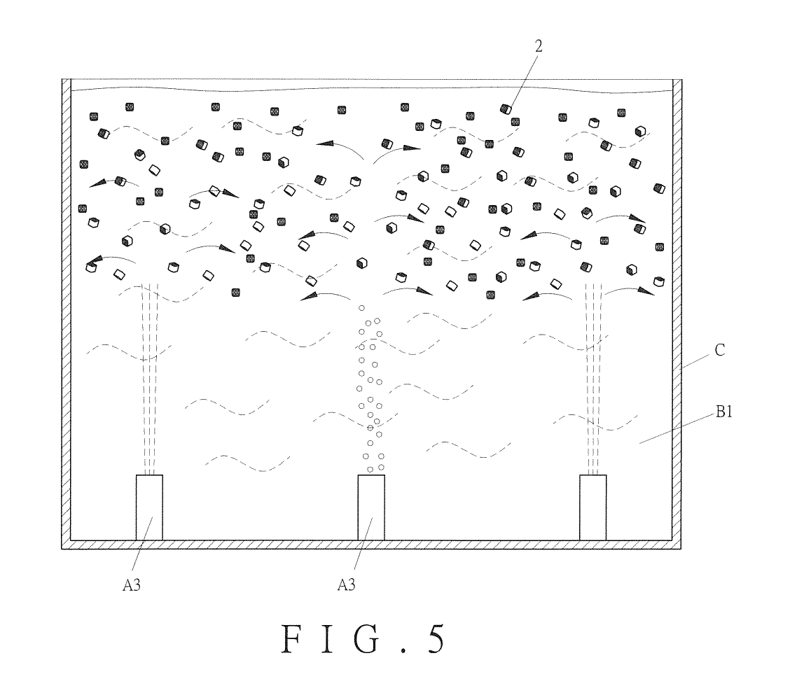

To use, referring to FIG. 4 and FIG. 5, an appropriate amount of liquid B1 is injected into an aquaculture tank C where an appropriate number of main bodies 2 are placed. Then, a water flow or bubbles are input into the aquaculture tank C via at least one dynamic water-flow outlet A3 in order for the water flow or bubbles to hit the main bodies 2 in the liquid Bi. When the main bodies 2 are immersed in the liquid B1, the through holes 22 retain the liquid B1 flowing therein. More specifically, the liquid B1 is rapidly guided into the through holes 22 by the surface tension or viscosity (see FIG. 3) generated at the two openings 23 of each through hole 22. The surface tension or viscosity also makes the liquid B1 stay in each through hole 22 without flowing therethrough immediately. Thus, the main bodies 2 retain the liquid B1 in the through holes 22. The liquid B1 retained in the middle section of each through hole 22 enable reproduction of microorganisms or plankton such as bacteria, microalgae, and SS-type rotifers. Since the retained liquid B1 will not dry out, the microorganisms or plankton (e.g., bacteria, microalgae and SS-type rotifers) can live in the liquid B1 in each through hole 22 as long as allowed. Moreover, the microorganisms or plankton (e.g., bacteria, microalgae and SS-type rotifers) can be in contact with the liquid B1 outside the through holes 22 via the two openings 23 of each through hole 22 and can therefore feed on and take nutrients from the liquid B1.

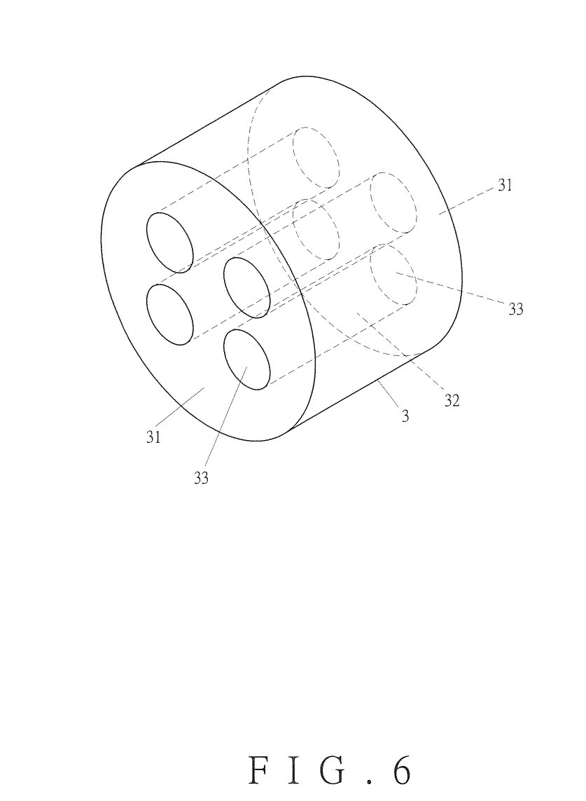

The bio-block in the third embodiment of the present invention is shown in FIG. 6 and has a cylindrical main body 3 with at least two surfaces 31. The main body 3 is provided with at least one through hole 32 having a circular cross section. The through hole 32 has a diameter of 2.5±0.25 mm and a depth of 10.0±1.0 mm The through hole 32 forms two openings 33 in the two surfaces 31 respectively.

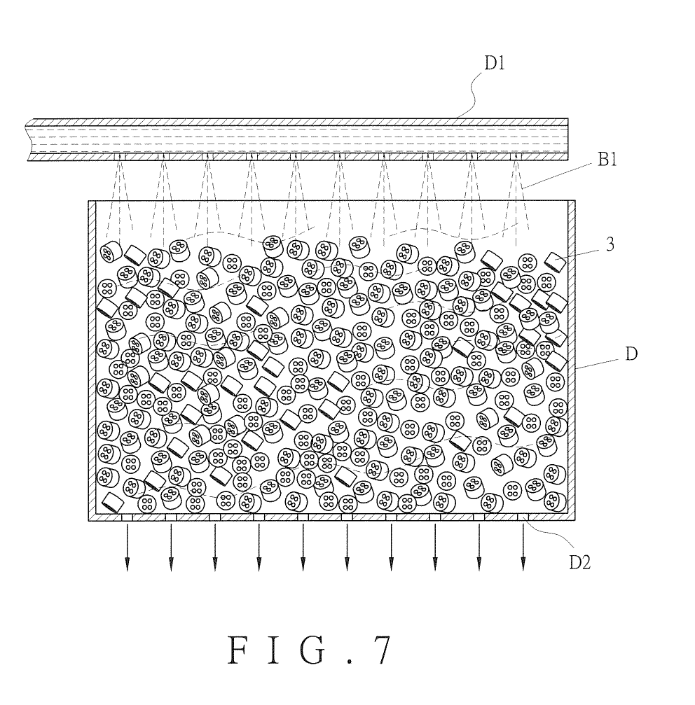

To use, referring to FIG. 6 and FIG. 7, an appropriate number of main bodies 3 are placed in a filter tank D for fish farming. A liquid B1 is evenly sprayed into the filter tank D from a rain bar D1 above the filter tank D, flows through the main bodies 3, and is drained through the drain holes D2 at the bottom of the filter tank D. The liquid

B1 can be retained in the through holes 32 because surface tension or viscosity (see FIG. 3) is generated at the two openings 33 of each through hole 32 to guide the liquid B1 rapidly into the through hole 32 and to keep the liquid B1 staying in the through hole 32 without flowing through the through hole 32 immediately. Thus, the main bodies 3 retain the liquid B1 in the through holes 32. The liquid B1 in the middle section of each through hole 32 enables microorganisms or plankton to reproduce, and the bacteria can live as long as they are allowed due to the fact that the retained liquid B1 will not dry out. The microorganisms or plankton can in contact with the liquid B1 outside the through holes 32 via the two openings 33 of each through hole 32 and can therefore feed on and take nutrients from the liquid B1.

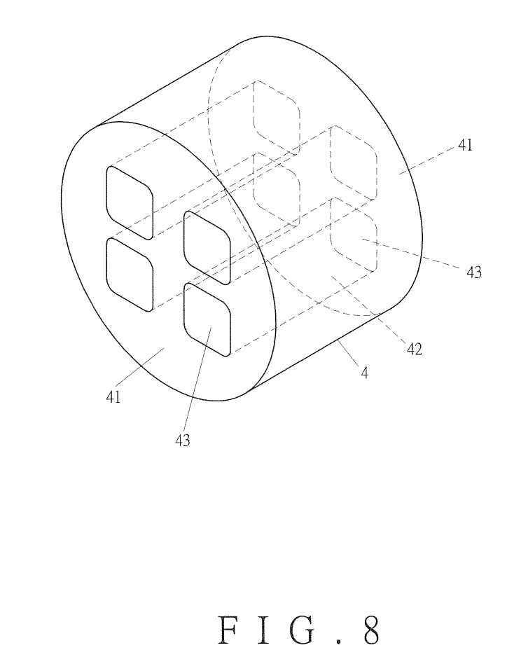

FIG. 8 shows the bio-block in the fourth embodiment of the present invention. The bio-block has a cylindrical main body 4 with at least two surfaces 41. The main body 4 is provided with at least one through hole 42 having a square cross section. The through hole 42 has a diameter of 2.5±0.25 mm, wherein the diameter of the through hole 42 refers to the distance between any two opposite sides, or the length of either diagonal, of the square cross section. Also, the through hole 42 has a depth of 10.0±1.0 mm The through hole 42 forms two openings 43 in the two surfaces 41 respectively.

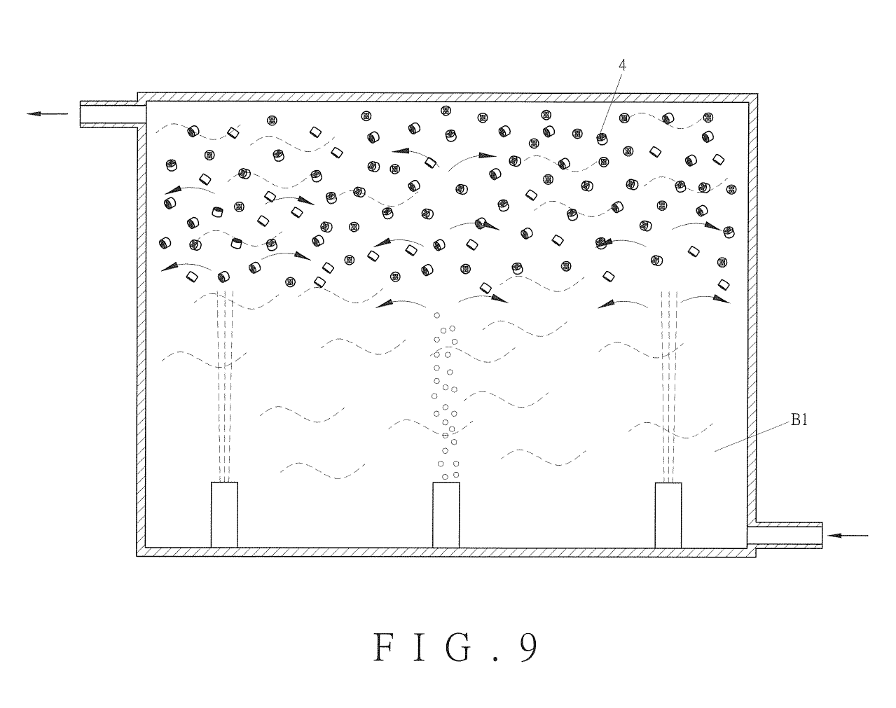

To use, referring to FIG. 8 and FIG. 9, the main body 4 is immersed in a liquid B1 such that the liquid B1 is rapidly guided into the trough hole 42 and will stay therein without flowing therethrough immediately, thanks to the surface tension or viscosity generated at the two openings 43 of the through hole 42. Thus, the main body 4 retains the liquid B1 in the through hole 42. The liquid B1 in the through hole 42 can be used to cultivate microorganisms or plankton such as bacteria, microalgae, and SS-type rotifers. Given the same volume, the bio-block can cultivate various microorganisms or plankton in much greater quantities and at much higher speed than similar products.

The four embodiments described above are provided for illustrative purposes only and should not be construed as restrictive of the scope of patent protection sought by the applicant. All simple, equivalent changes and substitutions made according to the appended claims and the disclosure of this specification should fall within the scope of the present invention.

What is claimed is:

1. A bio-block, comprising a main body provided with at least one through hole, the through hole having two ends each forming an opening in the main body, the through hole having a diameter of 2.5±0.25 mm and a depth of 10.0±1.0 mm, wherein when the main body is immersed in a liquid, the through hole retains the liquid flowing therein, and the liquid retained in the through hole generates surface tension or viscosity at the two openings and is thereby kept from flowing through the through hole; and wherein the liquid retained in the through hole is used to grow a microorganism or a plankter.

2. The bio-block of claim 1, wherein the through hole has a circular or square cross section.

3. The bio-block of claim 2, wherein when the through hole has the square cross section, the diameter of the through hole is a distance between any two opposite sides of the square cross section.

4. The bio-block of claim 2, wherein when the through hole has the square cross section, the diameter of the through hole is a length of either diagonal of the square cross section.

5. The bio-block of claim 1, wherein the main body is a cube or a cylinder and has at least two surfaces, and the two openings are in the two surfaces respectively.

6. The bio-block of claim 5, wherein the through hole has a circular or square cross section.

7. The bio-block of claim 6, wherein when the through hole has the square cross section, the diameter of the through hole is a distance between any two opposite sides of the square cross section.

8. The bio-block of claim 6, wherein when the through hole has the square cross section, the diameter of the through hole is a length of either diagonal of the square cross section.
